(19) United States
(12) Patent Application Publication
(10) Pub. No.: US 2005/0082368 A1
(43) Pub. Date: Apr. 21, 2005

(54) Wireless communication system capable of visually indicating failure of transmission and reception states

(75) Inventor: Fumio Watanabe, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/964,279

(22) Filed: Oct. 12, 2004

(30) Foreign Application Priority Data
Oct. 15, 2003 (JP) 2003-355607

(51) Int. Cl. G06K 7/08

(52) U.S. Cl. 235/451

(57) ABSTRACT

According to the present invention, there is provided a wireless communication system with a simplified structure by which the occurrence of failure in a reception state or a transmission state is visually indicated. The wireless communication system comprises a transceiver body 1 having a transmitter 2 and a receiver 3, and an external antenna array 5 having an antenna element 7 and connected to the transceiver body 1. A light emitting diode (LED) 9e that emits light by a transmission signal transmitted from the transmitter 2 to the antenna element 7 and a reception signal supplied from the antenna element 7 to the receiver 3 is provided in the external antenna array 5, so that the LED 9e is visually perceived from the outside.

### BACKGROUND OF THE INVENTION

1. Field of the Invention

The present invention relates to a wireless communication system, and more particularly, to a wireless communication system configured to visually indicate the occurrence and extent of failure in a reception state or a transmission state.

2. Description of the Related Art

A conventional wireless communication system will be described with reference to FIGS. 4 and 5. In detail, FIG. 4 shows an external appearance of the conventional wireless communication system, and FIG. 5 is a block diagram of the conventional wireless communication system.

In FIGS. 3 and 4, an antenna array 102 is mounted on a main body 101 of the wireless communication system and various circuits are provided in the main body 101. When communication is carried out so that a transmission wave is output from a transmitter 108 and a transmission signal is output to a driver 106, the driver 106 turns on a lamp provided in a light-emitter 107. The lamp is provided in the light-emitter 107 for transmission.

On the other hand, for reception, receivers 103 and 104 receive and detect waves supplied from various antenna elements of the antenna array 102, respectively, and reception levels thereof are determined by a reception determiner 105. An antenna element having a higher reception level is selected by the reception determiner 105 and a reception wave thereof is transmitted to a demodulator 109. In addition, the reception determiner 105 transmits information on the selected antenna element to the driver 106. Then, the driver 106 turns on the lamp of the light-emitter 107 allocated to the selected antenna element. Light produced when the lamp is turned on is transmitted outside through an optical fiber (not shown) and the like, for example.

If the receiver 103 is continuously selected, the corresponding lamp is continuously turned on. If any change in the reception state occurs so that reception intensity of the receiver 104 increases, the reception determiner 105 transmits a signal supplied from the receiver 104 to the demodulator 109 and transmits information on a newly selected antenna element to the driver 106. Then, the driver 106 turns the currently lit lamp off, and turns on a light-emitter allocated to the newly selected antenna element (for example, see Japanese Unexamined Patent Application Publication No. 06-216618 (FIGS. 1 and 2)).

However, in the conventional wireless communication system, a driver is provided in order to emit light from an antenna, which makes the system expensive. In addition, another drawback of the conventional wireless communication system is the difficulty of visually indicating the occurrence of failure in the reception state or transmission state.

### SUMMARY OF THE INVENTION

Accordingly, the present invention is designed to solve the above problems, and it is an object of the present invention to provide a wireless communication system with a simplified structure by which the occurrence of failure in a reception state or a transmission state can be visually indicated.

To achieve the above object, in a first aspect of the present invention, there is provided a wireless communication system comprising a transceiver body having a transmitter and a receiver, and an external antenna array having an antenna element and connected to the transceiver body, wherein a light emitting diode (LED) that emits light by a transmission signal transmitted from the transmitter to the antenna element and a reception signal supplied from the antenna element to the receiver is provided in the external antenna array, so that the LED is visually perceived from the outside.

In a second aspect of the present invention, the antenna array includes a feeding line for connecting the antenna element to the transceiver body and a closed loop circuit having the LED inserted thereto in series, the closed loop circuit being connected to the feeding line.

In a third aspect of the present invention, the closed loop circuit includes a connection line disposed parallel to the feeding line to be connected thereto, and resistors connected in series at both ends of the connection line, the LED being inserted between the two resistors.

In a fourth aspect of the present invention, a substrate on which the antenna element is mounted is accommodated in the external antenna array, and the feeding line and the closed loop circuit are disposed on the substrate.

In a fifth aspect of the present invention, a detecting diode is inserted into the LED in series.

### BRIEF DESCRIPTION OF THE DRAWINGS

FIG. 1 is a diagram illustrating the external appearance of a wireless communication system according to the present invention;

FIG. 2 is a block diagram of the wireless communication system according to the present invention;

FIG. 3 is an internal perspective view of an external antenna array in the wireless communication system according to the present invention;

FIG. 4 is a diagram illustrating the external appearance of a conventional wireless communication system; and

FIG. 5 is a block diagram of the conventional wireless communication system.

### DESCRIPTION OF THE PREFERRED EMBODIMENT

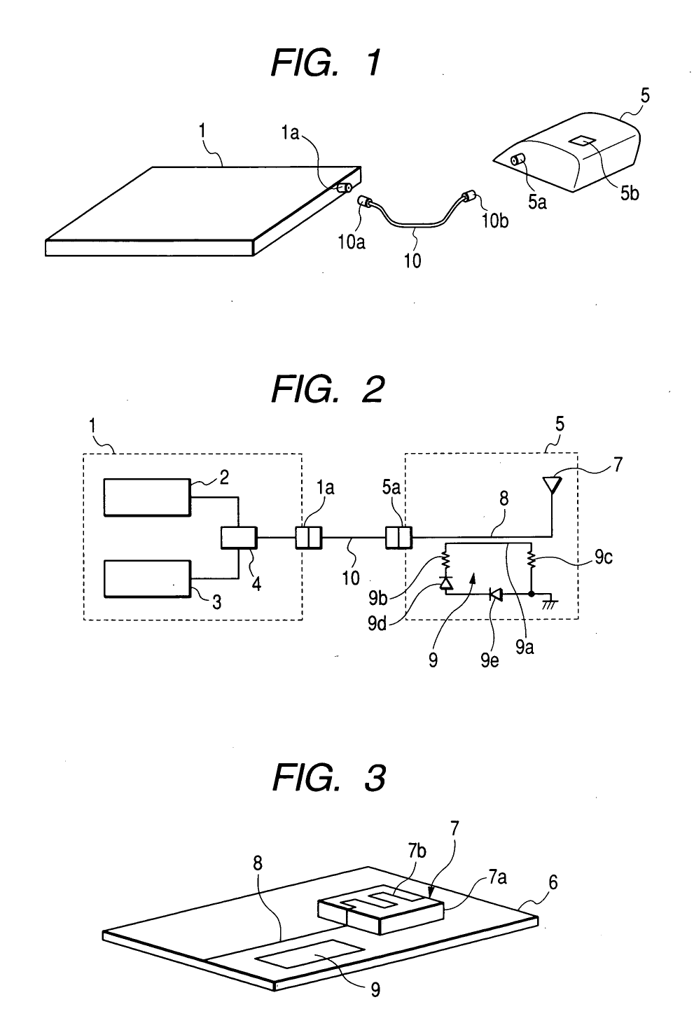

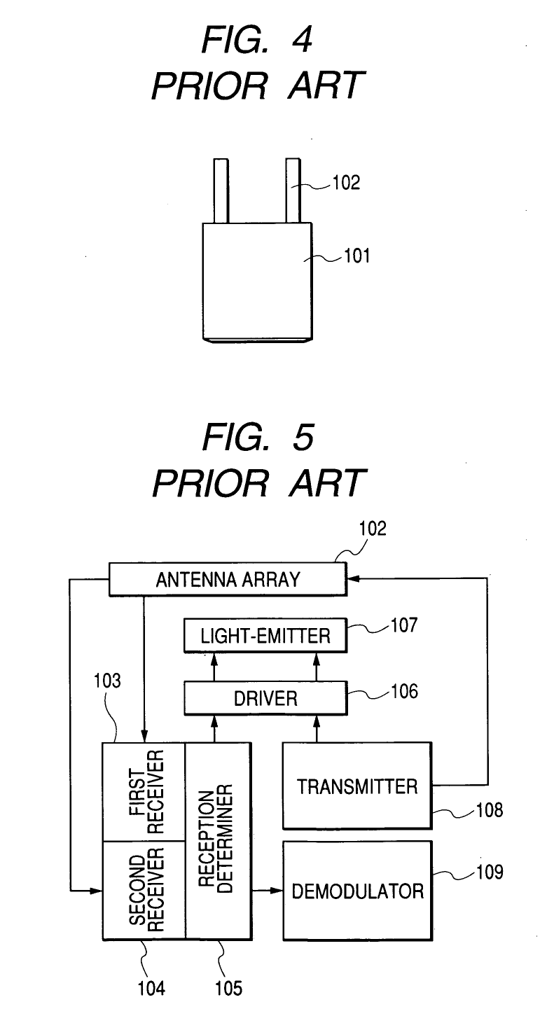

A wireless communication system according to the present invention will now be described with reference to FIGS. 1 to 3. FIG. 1 is a diagram illustrating the external appearance of a wireless communication system according to the present invention, FIG. 2 is a block diagram of the wireless communication system according to the present invention, and FIG. 3 is an internal perspective view of an external antenna array in the wireless communication system according to the present invention. In FIGS. 1 to 3, a connector 1a for connecting an external antenna array 2 is mounted on a lateral surface of a card-type transceiver body 1 for wireless LAN, and a transmitter 2 and a receiver 3 are provided inside the transceiver body 1. Further, the transmitter 2 and the receiver 3 are connected to the connector 1a via an antenna switch 4. The transceiver body 1 is mounted on a personal computer in a state in which the connector 1a protrudes outwardly.

As shown in FIG. 1, an external antenna array 5 is hemispherical and a surface thereof is covered by a resin case. A connector 5a for connecting the external antenna array 5 to the transceiver body 1 is mounted on a lateral surface of the external antenna array 5, and a small window 5b enclosed with a transparent acryl plate (not shown) is provided on a top surface of the external antenna array 5. In addition, a substrate 6 is accommodated in the external antenna array 5, and an antenna element 7 is mounted on the substrate 6. The antenna element 7 comprises a dielectric block 7a and a meandering antenna line 7b coated on the surface of the dielectric block 7a. The antenna line 7b is connected to a feeding line 8 disposed on the substrate 6. In addition, the feeding line 8 is connected to the connector 5a.

A closed loop circuit 9 connected to the feeding line 8 is provided on the substrate 6. The closed loop circuit 9 comprises a connection line 9a disposed parallel to the feeding line 8 so as to be connected to the feeding line 8, and a detecting diode 9d and a light-emitting diode (LED) 9e, which form a closed loop together with resistors 9b and 9c connected in series at both ends of the connection line 9a. Further, the LED 9e may be provided directly under the window 5b to be mounted on the substrate 6, or may be attached to a case from the internal side of the window 5b.

The transceiver body 1 and the external antenna array 5 are connected to each other through a cable 10. Connectors 10a and 10b are provided at both ends of the cable 10. The connector 10a is connected to the connector 1a of the transceiver body 1, and the connector 10b is connected to the connector 5a of the external antenna array 5.

In the above-mentioned configuration, when the external antenna array 5 is connected to the transceiver body 1, a transmission signal output from the transmitter 2 and a reception signal output from the antenna element 7 pass through the feeding line 8. However, in this case, the connection line 9a of the closed loop circuit 9 is connected to the feeding line 8 so that a current flows the connection line 9a. Thus, the transmission signal or the reception signal can be detected by means of the detecting diode 9d. Then, the LED 9e is allowed to emit light by a detection voltage. The light emitted from the LED 9e is proportional to the intensity of a transmission signal or a reception signal. Such an emission state can be visually perceived through the window 5b provided in the external antenna array 6 easily. Therefore, since the intensity of the signal is determined by the amount of light, the optimal reception or transmission state can be obtained by varying the direction of the external antenna array 5.

Since the LED 9e emits light using the transmission signal or the reception signal as an energy source, emission of light can be achieved only by inserting the LED 9e into the closed loop circuit 9. Also, since the resistors 9b and 9c are connected to both ends of the connection line 9a, there is substantially no a rapid change in the impedance of the feeding line 8. Further, the LED 9e itself can perform the detection and then can emit light without using the detecting diode 9d.

According to the present invention, the wireless communication system comprises a transceiver body and an external antenna array. A light emitting diode (LED) that emits light by a transmission signal transmitted from the transmitter to the antenna element and a reception signal supplied from the antenna element to the receiver is provided in the external antenna array. Further, since the LED is provided so as to be visually perceived from the outside, the LED emits light according to the intensity of the transmission signal or the reception signal, which is visually perceived from the outside. Therefore, the optimal reception or transmission state can be obtained by varying the direction of the external antenna array.

Further, in the antenna array, a feeding line for connecting the antenna element to the transceiver body and a closed loop circuit in which the LED is inserted in series are provided, and the closed loop circuit is connected to the feeding line. Thus, the LED is allowed to emit light using the transmission signal or the reception signal.

Furthermore, the closed loop circuit includes a connection line disposed parallel to the feeding line to be connected thereto, and resistors connected in series at both ends of the connection line. Also, the LED is inserted between the two resistors. Thus, there is substantially no a rapid change in the impedance of the feeding line.

Furthermore, a substrate on which the antenna element is mounted is accommodated in the external antenna array, and the feeding line and the closed loop circuit are provided on the substrate. Thus, the feeding line and the closed loop circuit can be easily connected to each other.

Furthermore, since the detecting diode is inserted into the LED in series, it is possible to increase detection sensitivity.

1. A wireless communication system comprising:
a transceiver body having a transmitter and a receiver; and
an external antenna array having an antenna element and connected to the transceiver body,
wherein a light emitting diode (LED) that emits light by a transmission signal transmitted from the transmitter to the antenna element and a reception signal supplied from the antenna element to the receiver is provided in the external antenna array, so that the LED is visually perceived from the outside.

2. The wireless communication system according to claim 1,
wherein the antenna array comprises a feeding line for connecting the antenna element to the transceiver body, and a closed loop circuit having the LED inserted thereto in series, the closed loop circuit being connected to the feeding line.

3. The wireless communication system according to claim 2,
wherein the closed loop circuit includes a connection line disposed parallel to the feeding line to be connected thereto, and resistors connected in series at both ends of the connection line, the LED being inserted between the two resistors.

4. The wireless communication system according to claim 2,
wherein a substrate on which the antenna element is mounted is accommodated in the external antenna array, and the feeding line and the closed loop circuit are disposed on the substrate.

5. The wireless communication system according to claim 2,
wherein a detecting diode is inserted into the closed loop circuit in series with the LED.
